(19) United States
(12) Patent Application Publication
(10) Pub. No.: US 2020/0148487 A1
(43) Pub. Date: May 14, 2020

(54) COLLECTION MECHANISM OF WASHING DEVICE AND WASHING DEVICE

(71) Applicant: G-WINNER ENVIRONMENTAL PROTECTION CO., LTD., Taichung City (TW)

(72) Inventor: PING-YUAN LIAO, Taichung City (TW)

(21) Appl. No.: 16/674,479

(22) Filed: Nov. 5, 2019

(30) Foreign Application Priority Data
Nov. 8, 2018 (TW) 107139727

(51) Int. Cl. B65G 57/03; A47L 15/00; A47L 15/24

(52) U.S. Cl. CPC B65G 57/03; A47L 15/246; A47L 15/248; A47L 15/0076

(57) ABSTRACT

A collection mechanism of washing device includes: a receiving space for receiving an object from a conveyance mechanism; a collection space above the receiving space for receiving the stacked objects; a lifting mechanism below the receiving space for pushing the object from the receiving space to the collection space; a supporting element between the receiving space and the collection space, pivotable between a support position and an erected position. The objects in the collection space are placed on the supporting element at the support position. When the object in the receiving space is pushed by the lifting mechanism, the supporting element is pushed to the erected position to allow the object to enter the collection space under the stacked objects. When the objects are higher than the supporting element, the supporting element pivots back to the support position to support the objects again.

### BACKGROUND OF THE INVENTION

### Field of the Invention

The present invention relates to a washing device, more especially to a collection mechanism of washing device.

### Description of the Prior Art

Washing device or washing machine is usually used for washing tableware or container in a large amount to increase efficiency. Normal washing device includes one-time basket-type and continuous conveyor-type wherein the conveyor-type is more efficient and popular, as shown in patents TW 1421053, TW 579827, and TW 360098.

However, when the objects are transported to the end of the conveyor, the objects have to be taken away and stacked together by human to increase the labor cost.

To solve this problem, a collection mechanism as shown in patent TW M468356 is provided. The automatic liftable plate receives the object on the conveyor. When the liftable plate received a new object, it moves downward a little to receive the next object. However, the distance that the liftable plate moves every time has to be set in advance according to the thickness of the object. In addition, the object is placed onto other stacked objects laterally, so the object may be delivered unsuccessfully.

### SUMMARY OF THE INVENTION

The main object of the present invention is to provide a collection mechanism of washing device and a washing device having the collection mechanism to collect the washed objected efficiently to reduce labor cost.

To achieve the above and other objects, the collection mechanism of washing device of the present invention is adapted for collecting and stacking objects which have been washed by a washing device. The washing device includes a washing mechanism and a conveyance mechanism. The conveyance mechanism has a start position and a final position. The objects are transported from the start position toward the final position by the conveyance mechanism. The objects are washed by the washing mechanism during transported by the conveyance mechanism. The collection mechanism of washing device is located at the final position of the conveyance mechanism. The collection mechanism of washing device includes a receiving space, a collection space, a lifting mechanism, and a supporting mechanism.

The receiving space is located beside the final position of the conveyance mechanism for receiving one of the objects. The collection space is located above the receiving space for receiving a plurality of said objects which are stacked together. The lifting mechanism is located below the receiving space and is movable vertically. The lifting mechanism is adapted for pushing the object in the receiving space upward into the collection space.

The supporting mechanism is located between the receiving space and the collection space and includes at least one supporting element. The at least one supporting element is pivotable between a support position and an erected position and retains at the support position normally.

When the at least one supporting element is at the support position, the objects in the collection space are placed on the at least one supporting element to be prevented from falling into the receiving space. When the object in the receiving space is pushed upward by the lifting mechanism to abut against the at least one supporting element at the support position, the at least one supporting element is pushed upward to pivot to the erected position so that the object in the receiving space is further pushed into the collection space to be located below the objects in the collection space. When the lowest object is pushed by the lifting mechanism to a position higher than the at least one supporting element, the at least one supporting element pivots back to the support position. When the lifting mechanism moves downward to a position lower than the at least one supporting element, the objects in the collection space are placed on the at least one supporting element again.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a stereogram of the present invention at an other angle;

FIG. 3 and FIG. 4 are illustrations of operation of the present invention;

FIG. 5 is a partial enlargement of the present invention;

FIG. 6 and FIG. 7 are lateral views showing operation states of the present invention.

### DETAILED DESCRIPTION OF THE PREFERRED EMBODIMENTS

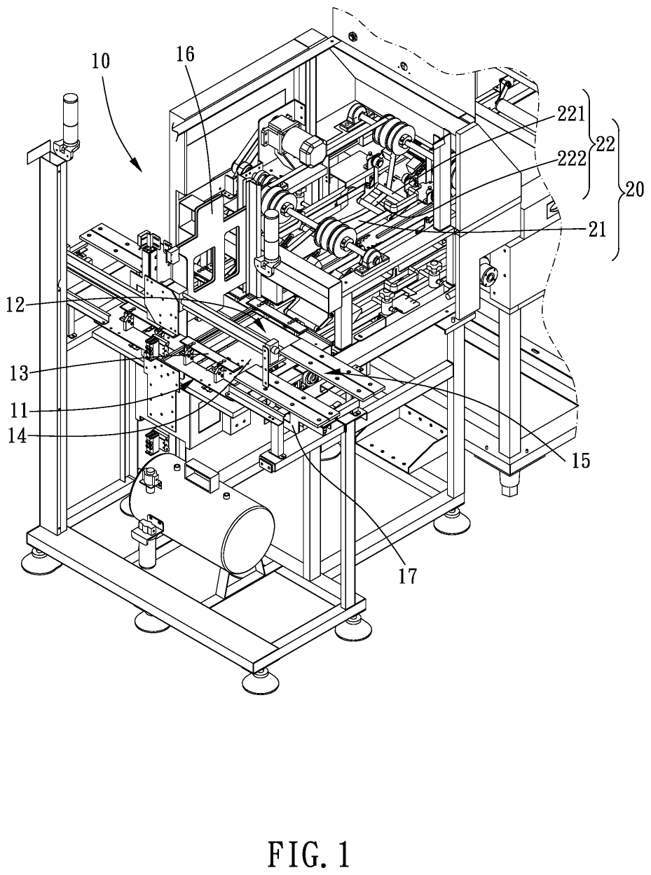

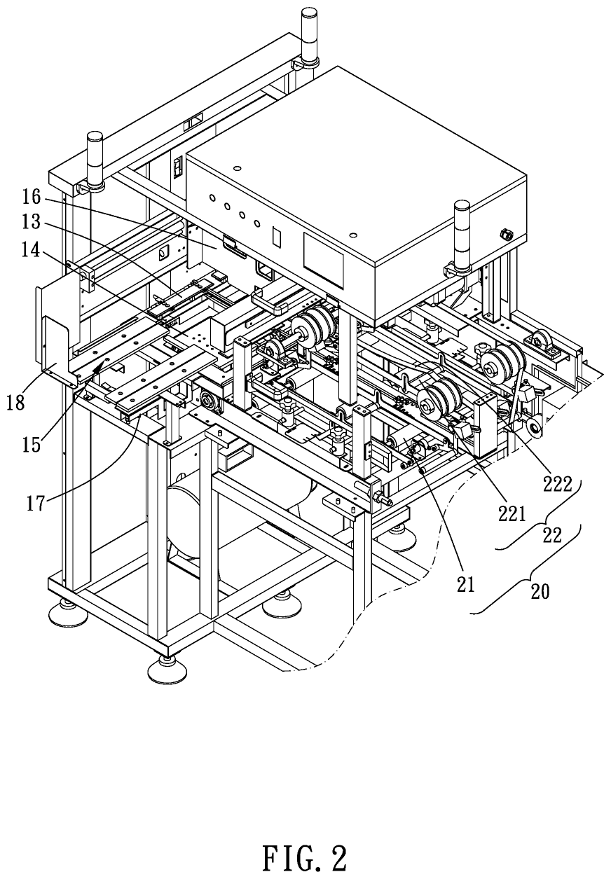

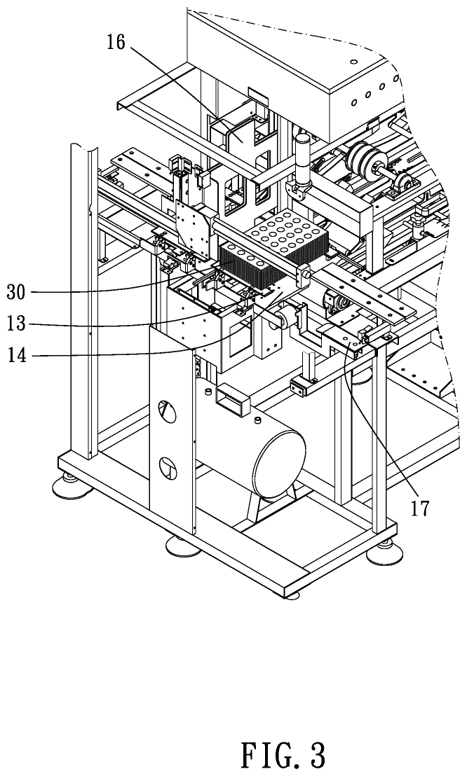

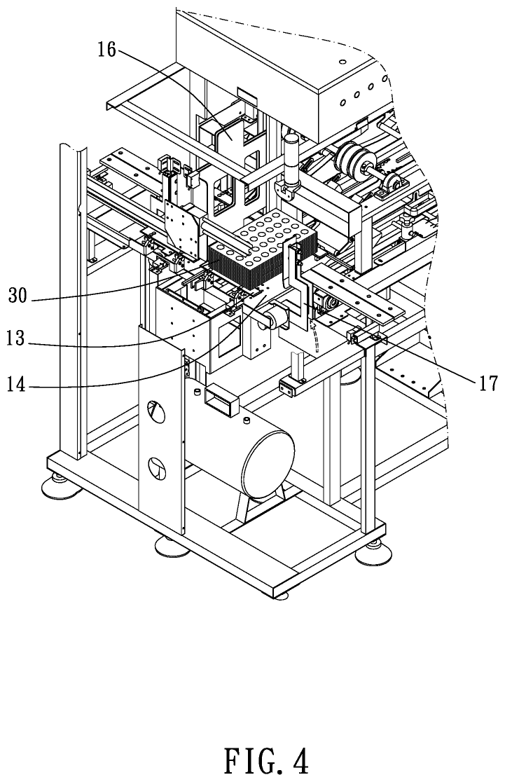

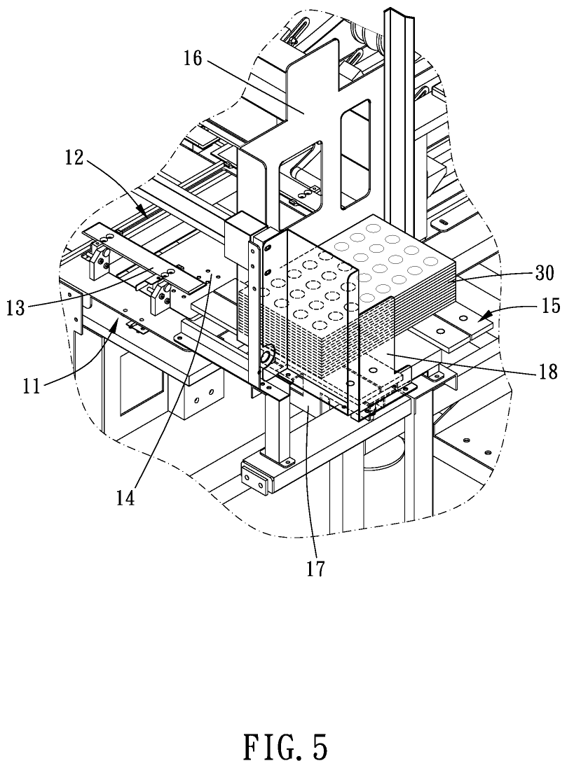

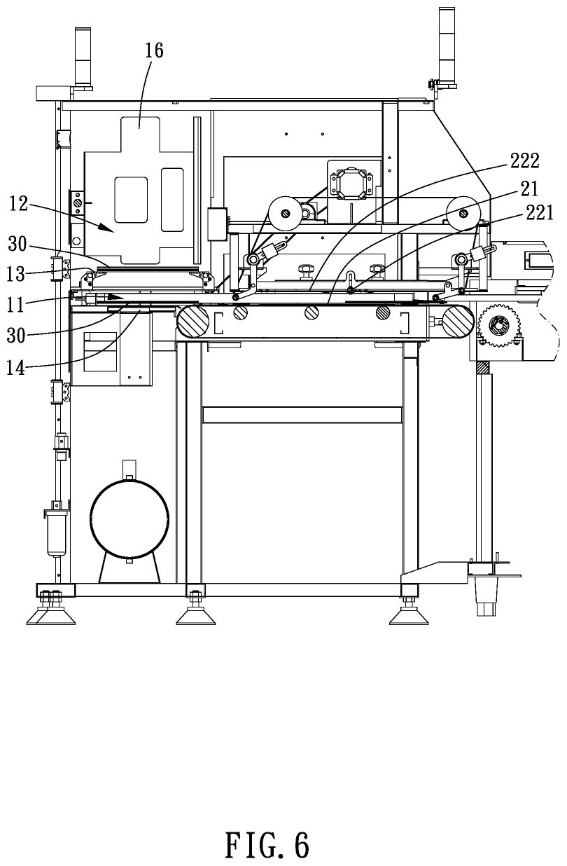

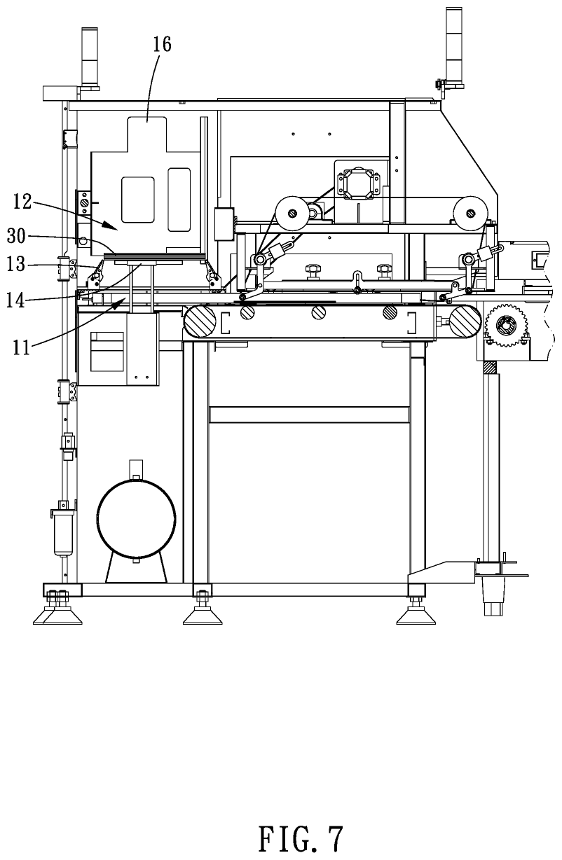

Please refer to FIG. 1 to FIG. 7, the collection mechanism 10 of washing device of the present invention is adapted for collecting and stacking objects 30 which have been washed by a washing device. The washing device includes a washing mechanism and a conveyance mechanism 20. The conveyance mechanism 20 has a start position and a final position. The objects 30 are transported from the start position toward the final position by the conveyance mechanism 20. The objects 30 are washed by the washing mechanism during transported by the conveyance mechanism 20. The collection mechanism 10 of washing device is located at the final position of the conveyance mechanism 20. The collection mechanism 10 of washing device includes a receiving space 11, a collection space 12, a lifting mechanism, and a supporting mechanism.

The receiving space 11 is located beside the final position of the conveyance mechanism 20 for receiving one of the objects 30. The collection space 12 is located above the receiving space 11 for receiving a plurality of said objects 30 which are stacked together. The lifting mechanism is located below the receiving space 11 and is movable vertically. The lifting mechanism is adapted for pushing the object 30 in the receiving space 11 upward into the collection space 12. The supporting mechanism is located between the receiving space 11 and the collection space 12 and includes at least one supporting element. The at least one supporting element is pivotable between a support position and an erected position and retains at the support position normally.

When the at least one supporting element is at the support position, the objects 30 in the collection space 12 are placed on the at least one supporting element to be prevented from falling into the receiving space 11. When the object 30 in the receiving space 11 is pushed upward by the lifting mechanism to abut against the at least one supporting element at the support position, the at least one supporting element is pushed upward to pivot to the erected position so that the object 30 in the receiving space 11 is further pushed into the collection space 12 to be located below the objects 30 in the collection space 12. When the lowest object is pushed by the lifting mechanism to a position higher than the at least one supporting element, the at least one supporting element pivots back to the support position. When the lifting mechanism moves downward to a position lower than the at least one supporting element, the objects 30 in the collection space 12 are placed on the at least one supporting element again.

In other possible embodiments, the collection mechanism of washing device further includes a conveyance mechanism. The conveyance mechanism has a start position and a final position. The objects are transported from the start position toward the final position by the conveyance mechanism. The receiving space is located beside the final position of the conveyance mechanism.

In the present embodiment, the collection mechanism 10 further includes a storage space 15 and a movable stopping plate 16. A direction from the storage space 15 to the movable stopping plate 16 is perpendicular to a transporting direction of the conveyance mechanism 20. The storage space 15 and the movable stopping plate 16 are located at two sides of the collection space 12. The movable stopping plate 16 is movable toward the storage space 15 to push the objects 30 in the collection space 12 into the storage space 15. Besides, a pushing element 17 is also included. The pushing element 17 is pivotable between an original position and a pushing position. When the pushing element 17 is at the original position, the pushing element is below the supporting mechanism. When the pushing element 17 is at the pushing position, the pushing element pushes the objects 30 from a side opposite to the movable stopping plate 16 toward the movable stopping plate 16. Thereby, the objects 30 can be aligned well and abut against the movable stopping plate 16 closer.

Besides, a height detection mechanism 18 is also included. The height detection mechanism 18 is arranged in the storage space 15 to detect a height of the objects 30 which are stacked together in the storage space 15. When the stacked objects 30 are too high, the height detection mechanism 18 warns the user by warning light or others, or stops the washing device directly.

Specifically, the at least one supporting element includes two supporting plates 13. The two supporting plates 13 are arranged separately and parallel. The lifting mechanism includes a pushing plate 14. A width of the pushing plate 14 is smaller than a width of a gap between the two supporting plates 13 to be able to pass through the gap. The pushing element 17 is located between the two supporting plates 13.

The present invention also provides a washing device including the collection mechanism 10 mentioned above. The washing device also includes a washing mechanism (not shown in the drawings) and a conveyance mechanism 20. The conveyance mechanism 20 has a start position and a final position. The objects 30 are transported from the start position toward the final position by the conveyance mechanism 20. The objects 30 are washed by the washing mechanism during transported by the conveyance mechanism 20.

Specifically, the conveyance mechanism 20 includes a conveyor 21 and at least one pressing mechanism 22. The conveyor 20 is adapted for the objects 30 being placed thereon to transport the objects 30. The at least one pressing mechanism 22 is located above the conveyor 21 to press the objects 30 downward to position the objects 30 on the conveyor 21. More specifically, the at least one pressing mechanism 22 includes a plurality of belts 222 and a plurality of rolling axles 221. The rolling axles 221 are spacedly arranged and are perpendicular to a transporting direction of the conveyor 21 respectively. The rolling axles 221 are located above or below the belts 222 alternately. That is, the belts 222 extend above or below the rolling axles 221 alternately.

In use, the objects 30 are transported by the conveyance mechanism 20 one by one and are washed and dried during passing through the washing mechanism. The object 30 arriving at the final position of the conveyance mechanism 20 further enters the receiving space 11. When the pushing plate 14 detected that the object 30 has entered, it pushes the object 30 upward. When the object 30 touches the supporting plates 13, the two supporting plates 13 are pivoted toward the erected position if the object 30 is further pushed upward by the lifting mechanism. Thereby, the object 30 and the pushing plate 14 are able to enter the collection space 12. When the object 30 is lifted to a position higher than the two supporting plates 13, the two supporting plates 13 are not obstructed by the object 30 so as to pivot to the support position automatically. Thereafter, make the lifting mechanism move downward to a position lower than the receiving space 11, the objects 30 in the collection space 12 are placed on the two supporting plates 13 at the support position again. When the steps above are repeated, the object 30 can be placed under the previous object 30, and the pushing element 17 further pushes the stacked objects 30 toward the movable stopping plate 16 to make the objects 30 align well.

Thereafter, the stacked objects 30 can be pushed to the storage space 15 by the movable stopping plate 16, and the user can take the objects 30 away. When the movable stopping plate 16 moves back to the original position, the process of collection can be started again.

Optionally, the process can be edited and controlled by computer to achieve an automatic process of washing and collection. When errors occur, the computer can automatically stop the device.

What is claimed is:

1. A collection mechanism of washing device, adapted for collecting and stacking objects which have been washed by a washing device, the washing device including a washing mechanism and a conveyance mechanism, the conveyance mechanism having a start position and a final position, the objects being transported from the start position toward the final position by the conveyance mechanism, the objects being washed by the washing mechanism during transported by the conveyance mechanism, the collection mechanism of washing device being located at the final position of the conveyance mechanism, the collection mechanism of washing device including:
a receiving space, located beside the final position of the conveyance mechanism for receiving one of the objects;
a collection space, located above the receiving space for receiving a plurality of said objects which are stacked together;
a lifting mechanism, located below the receiving space and movable vertically, the lifting mechanism being adapted for pushing the object in the receiving space upward into the collection space;
a supporting mechanism, located between the receiving space and the collection space, including at least one supporting element, the at least one supporting element being pivotable between a support position and an erected position and retaining at the support position normally;
when the at least one supporting element is at the support position, the objects in the collection space being placed on the at least one supporting element to be prevented from falling into the receiving space;
when the object in the receiving space is pushed upward by the lifting mechanism to abut against the at least one supporting element at the support position, the at least one supporting element being pushed upward to pivot to the erected position so that the object in the receiving space is further pushed into the collection space to be located below the objects in the collection space; when the lowest object is pushed by the lifting mechanism to a position higher than the at least one supporting element, the at least one supporting element pivoting back to the support position;
when the lifting mechanism moves downward to a position lower than the at least one supporting element, the objects in the collection space being placed on the at least one supporting element again.

2. The collection mechanism of washing device of claim 1, further including a storage space and a movable stopping plate, a direction from the storage space to the movable stopping plate being perpendicular to a transporting direction of the conveyance mechanism, the storage space and the movable stopping plate being located at two sides of the collection space, the movable stopping plate being movable toward the storage space to push the objects in the collection space into the storage space.

3. The collection mechanism of washing device of claim 2, further including a pushing element, the pushing element being pivotable between an original position and a pushing position; when the pushing element is at the original position, the pushing element being below the supporting mechanism;
when the pushing element is at the pushing position, the pushing element pushing the objects from a side opposite to the movable stopping plate toward the movable stopping plate.

4. The collection mechanism of washing device of claim 2, further including a height detection mechanism, arranged in the storage space to detect a height of the objects which are stacked together in the storage space.

5. The collection mechanism of washing device of claim 1, wherein the at least one supporting element includes two supporting plates, the two supporting plates are arranged separately and parallel, the lifting mechanism includes a pushing plate, a width of the pushing plate is smaller than a width of a gap between the two supporting plates to be able to pass through the gap.

6. The collection mechanism of washing device of claim 1, further including a conveyance mechanism, the conveyance mechanism having a start position and a final position, the objects being transported from the start position toward the final position by the conveyance mechanism, the receiving space being located beside the final position of the conveyance mechanism.

7. A washing device, including a collection mechanism of washing device of claim 1, further including a washing mechanism and a conveyance mechanism, the conveyance mechanism having a start position and a final position, a plurality of objects being transported from the start position toward the final position by the conveyance mechanism, the objects being washed by the washing mechanism during transported by the conveyance mechanism.

8. The washing device of claim 7, wherein the conveyance mechanism includes a conveyor and at least one pressing mechanism, the conveyor is adapted for the objects being placed thereon to transport the objects, the at least one pressing mechanism is located above the conveyor to press the objects downward to position the objects on the conveyor.

9. The washing device of claim 8, wherein the at least one pressing mechanism includes a plurality of belts and a plurality of rolling axles, the rolling axles are spacedly arranged and are perpendicular to a transporting direction of the conveyor respectively, the rolling axles are located above or below the belts alternately.
